(19) United States
(12) Patent Application Publication
(10) Pub. No.: US 2014/0095460 A1
(43) Pub. Date: Apr. 3, 2014

(54) Crowdsourcing Viewable Events

(71) Applicant: Timothy Romanowski, Corvallis, OR (US)

(72) Inventor: Timothy Romanowski, Corvallis, OR (US)

(21) Appl. No.: 13/633,574

(22) Filed: Oct. 2, 2012

(51) Int. Cl. G06F 17/30

(52) U.S. Cl. 707/705; 707/812; 707/E17.044

(57) ABSTRACT

Embodiments are disclosed to provide the crowdsourcing of viewable events. Crowdsourcing can be used to determine what is viewable in a particular venue, such as a restaurant, bar, or private home. Information about venues and events is populated in a database by a plurality of users. Events are associated with venues by a crowdsourcing engine. Users wishing to view a particular event can find a venue showing that event through information provided by other users.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to determining venue-specific event participation, and more specifically, to using crowdsourcing to locate venues showing viewable events.

2. Description of the Related Art

It is well known within the related art that crowdsourcing is hugely successful in problem-solving tasks. Much like scientific research committees or focus groups, crowdsourcing is an activity in which an individual, an institution, a non-profit organization, or company proposes to a group of individuals of varying knowledge, heterogeneity, and number, via a flexible open call, the voluntary undertaking of a task.

The undertaking of the task, of variable complexity and modularity, and in which the crowd should participate bringing their work, money, knowledge and/or experience, always entails mutual benefit. The user will receive the satisfaction of a given type of need, be it economic, social recognition, self-esteem, or the development of individual skills, while the crowdsourcer will obtain and utilize to their advantage that what the user has brought to the venture, whose form will depend on the type of activity undertaken.

Within the related art, the advent of the Internet enhanced the ease of which crowdsourcing could be performed, and became a preferred method for distributing tasks or calling upon voluntary user input for completing said tasks. Crowdsourcing has revolutionized how music reaches listeners by enabling Pandora Internet Radio enthusiasts to collaboratively group and categorize music into genres and like-artist specific channels. The Galaxy Zoo Project has allowed amateur astrologists to classify over 50 million galaxies photographed in the Sloan Digital Sky Survey. The Internet encyclopedia, Wikipedia, relies predominantly on non-profit crowdsourcing to create, update, and maintain over 23 million pages of information.

Further enhancing distribution and collection of data, mobile devices allowed figures and data to be submitted from virtually anywhere a signal could be had. These devices untethered users from their home computers and allowed for situational and location-based inputs. Those being crowdsourced could report, without any delay, to the crowdsourcer, and as such, accuracy increased dramatically. As a side effect of this promptness, the type of distribution-based problems could evolve towards those based on real-time, present scenarios.

At present, implicit crowdsourcing and explicit crowdsourcing provide two separate avenues of obtaining and using sourced information. As a result of the increasing speeds at which data can be obtained, it could be said that this results in a need of an intermediate between the two whereas a user can input their own evaluations of an entity, while simultaneously, a database is implemented and immediately modified to alter a proposed output based upon the initial users input.

The immediate input, output, and retrieval of data to mobile devices is not a new to the art. Weather applications use input from mobile users and stations to establish current, accurate, location-based weather conditions that are easily accessed via mobile applications. Many car enthusiasts use mobile applications to report and compile known locations of traffic enforcement officers or speed traps.

Unfortunately, within the related art, there exists no method for predicting whether or not a specific sporting event will be televised at any plurality of venues, such as, but not limited to, a pub, bar, or restaurant. The present invention meets this need by allowing users to report the location of a specific event televised at the venue, and to issue it to a database of known events.

### BRIEF SUMMARY OF THE INVENTION

Embodiments are disclosed to provide the crowdsourcing of viewable events. Crowdsourcing can be used to determine what is viewable in a particular venue, such as a restaurant, bar, or private home. Users wishing to view a particular event will be able to find a venue showing the event through information provided by other users.

In a preferred embodiment of the present invention, users could enter venue information into a computer database. The information may contain the location of the venue and the event being shown. Users wishing to find a venue showing a specific event could retrieve the information from the computer database. The users may then be shown a list of venues that have been identified as showing the event.

In another preferred embodiment of the present invention, a user may launch a mobile application on a portable computing device. The mobile application may communicate with a database that provides information to the mobile application. The user may locate the venue in the mobile application and enter information regarding the event being shown. Other users may launch a mobile application on a portable computing device and retrieve information from a database about viewable events and the venues that are showing those events.

In yet another preferred embodiment of the present invention, a user may access the Internet and post information about a venue and the event that the venue is showing to a web page. Other users searching for a venue to view a particular event may access the Internet and retrieve information about venues or events from the web page.

The preceding embodiments are intended to be exemplary in nature and are not intended to be limiting. It is possible that those skilled in the art will see further embodiments of the present invention. Other objects and advantages of the present invention will be more fully apparent from the following disclosure.

### BRIEF DESCRIPTION OF THE SEVERAL VIEWS OF THE DRAWING(S)

FIG. 1 is a flowchart for crowdsourcing viewable events as according to one embodiment of the present invention;

FIG. 2 is a schematic block diagram of a client, server relationship for crowdsourcing viewable events as according to one embodiment of the present invention;

FIG. 3 is an exemplary window showing a check-in feature for crowdsourcing viewable events as according to one embodiment of the present invention; and

FIG. 4 is a schematic diagram of an exemplary crowdsourcing system as according to one embodiment of the present invention.

A further understanding of the present invention can be obtained by reference to preferred embodiments set forth in the illustrations of the accompanying drawings. Although the illustrated embodiments are merely exemplary for carrying out the present invention, both the organization and methods of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

Referring now to the present invention, there is described exemplary embodiments for crowdsourcing viewable events. For the purpose of clarity, the terms “crowdsourcing for viewable events”, “crowdsourcing viewable events”, “crowdsourcing events”, “crowdsourcing”, “present invention”, and “invention” may be used interchangeably to refer to the afore-mentioned crowdsourcing viewable events invention.

Several preferred embodiments for crowdsourcing viewable events are discussed in this section. However, the invention is not limited to these embodiments. The present invention includes any form of crowdsourcing that informs users of venues showing events. The crowdsourcing techniques are not limited in terms of number or type of users, information crowdsourced, communication method, event type, or venue.

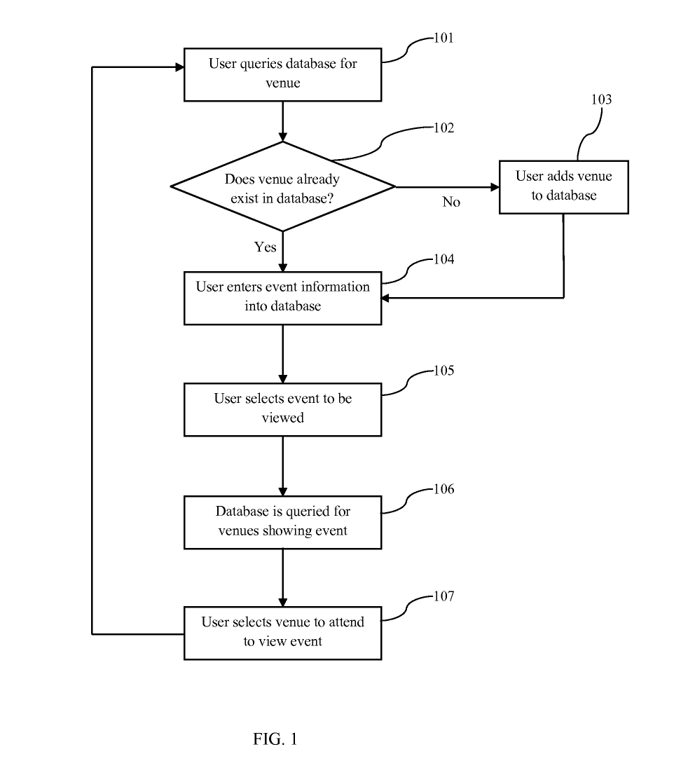

Referring now to FIG. 1, there is shown a flowchart for crowdsourcing viewable events as according to one embodiment of the present invention. A user entering a particular venue may query a database for the venue (101) to determine whether the venue already exists in the database (102). If the venue does not exist in the database, the user may add the venue to the database (103). Adding the venue to the database may include, but not be limited to adding information about the venue such as address, hours of operation, number of viewing devices, menu selections, type of establishment, or any other information requested by a crowdsourcing engine. If information about the venue is already in the database, or the user has added the venue to the database (103), the user may enter event information into the database (104). Event information may include the type of event being viewed, such as whether it is a sporting event, a news event, an entertainment event, the teams or participants in the event, the duration of the event, a rating for the event, or any other information requested by a crowdsourcing engine. Entering event information (104) may also include the user simply “checking in” at the particular venue. The check-in feature may allow a crowdsourcing engine to determine what event the user is viewing (104) and to associate that venue with the event being shown.

When looking for a venue that is showing a specific event, a user may select the event to be viewed (105). A database may be queried for venues that are showing the event (106). Event and venue information may be populated into the database by the user or by other users. A crowdsourcing engine may associate venues with viewable events based on user input. Once the database has been queried for venues showing the event (106), the user may be provided with a list of venues that are displaying the event and the user may select a venue to attend to view the event (107).

The crowdsourcing viewable events steps presented in FIG. 1 may be performed by way of an application, a computer program, or by accessing a website on the Internet. A cell phone, tablet computing device, laptop, or desktop, or any combination thereof may be used to perform the aforementioned steps.

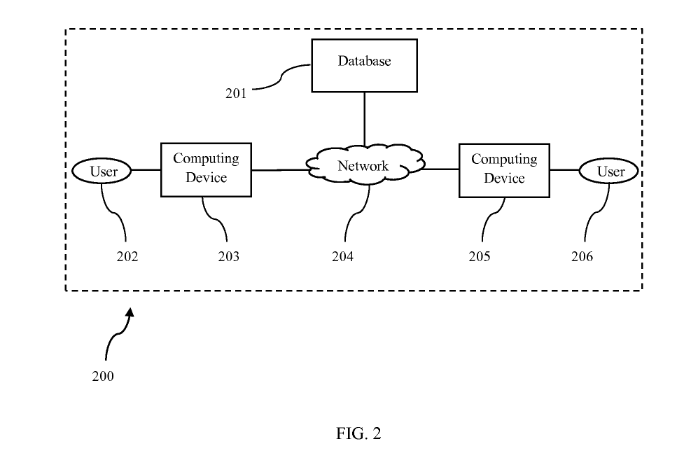

Referring now to FIG. 2, there is shown a schematic block diagram of a client, server relationship for crowdsourcing viewable events (200) as according to one embodiment of the present invention. Users (202, 206) may use a computing device (203, 205) to crowdsource viewable events. The users (202, 206) may be performing different crowdsourcing functions. One user (202) may be entering venue information or checking in at a particular venue while another use (206) may be searching for viewable events. Alternatively, all users (202 206) may be performing the same crowdsourcing function such as checking in at a venue. The crowdsourcing functions may include the crowdsourcing viewable events steps set forth in FIG. 1.

The computing devices (203, 205) may include any computational device such as laptops, palm devices, desktops, mobile devices, cellular telephones, tablets, smartphones, media storage devices, or any other device capable of performing crowdsourcing functions. The computing devices (203, 205) may connect to a network (204). Connections to the network may occur by way of wireless or wired communications. Wireless communications may include WiFi, cellular communications, or any other wireless communication protocols. The computing devices (203, 205) may access a database (201) through the network (204) in order to transmit or receive information. The database (201) may be a computer-implemented repository that contains venue information, viewable event information, or user information. Users (202, 206) may access information from the database (201) or retrieve information from the database in order to retrieve venue or viewable event information, or to upload venue or viewable event information.

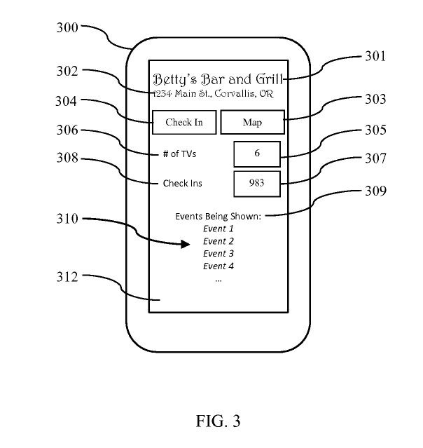

Referring now to FIG. 3, there is shown an exemplary window (312) with a check-in feature for crowdsourcing viewable events as according to one embodiment of the present invention. The window (312) may be contained within an application developed for crowdsourcing viewable events. A portable device such as a smartphone or tablet (300) may be used to execute the application. The window (312) may contain features that allow a user to crowdsource viewable events. The features may include the name of a venue (301), the address of a venue (302), a check-in button (304) for checking in at a particular venue, a map access button (303) that may retrieve a map showing the location of the venue, a number of TVs field (306) that displays the number of televisions (305) at the venue, a check-in field (308) that displays the number of check-ins (307) at a venue, and a viewable events field (309) that lists one or more viewable events (310) being shown at the venue. A user may access the window (312) within the application when the user wishes to enter information about an event or venue, or when the user wishes to retrieve information about an event or venue.

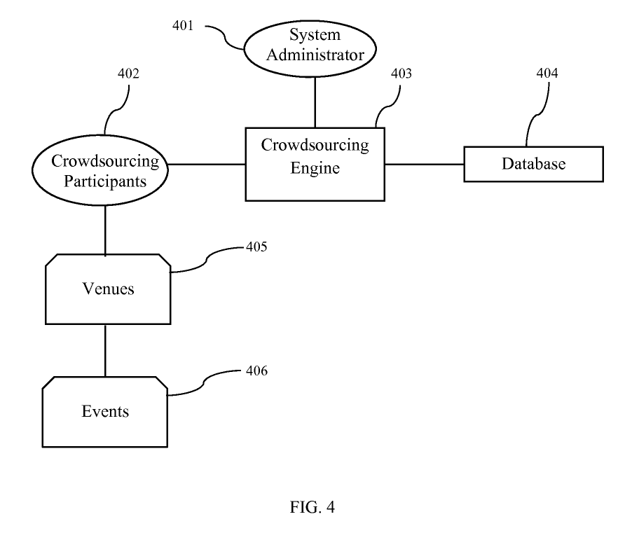

Referring now to FIG. 4, there is shown a schematic diagram of an exemplary crowdsourcing system as according to one embodiment of the present invention. The crowdsourcing system may include a system administrator (401) that could maintain system integrity, manage the crowdsourcing system, set permissions, add or remove information from the system, or perform any other function of a computer system administrator. Crowdsourcing participants (402) may be users that participate in the crowdsourcing system by transmitting or accessing information in a database (404) that is controlled by a crowdsourcing engine (403). The information may include information about a venue (405) such as its; address, hours of operation, number of viewing devices, menu selections, type of establishment, or any other information requested by a crowdsourcing engine (403). The information may also include information about a viewable event (406) such as the type of event being viewed, whether it is a sporting event, a news event, an entertainment event, the teams or participants in the event, the duration of the event, a rating for the event, or any other information requested by a crowdsourcing engine (403). The information may be used by the crowdsourcing participants (402) to let other crowdsourcing participants (402) know about a viewable event (406) being shown at a venue (405), or to find venues (405) showing a desired viewable event (406). The crowdsourcing engine (403) may contain the logic that operates the crowdsourcing system. One logic component may assimilate information from the crowdsourcing participants (402) and associate venues (405) with viewable events (406). Another logic component may be a gateway that controls information received from, or transmitted to, crowdsourcing participants (402).

It should be noted that the example software and/or firmware implementations described herein may be optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain exemplary embodiments of crowdsourcing viewable events have been described herein, the scope of coverage of this patent is not limited thereto. On the contrary, this patent covers all embodiments of a crowdsourcing viewable events fairly falling within the scope of the invention either literally or under the doctrine of equivalents.

With respect to the above description then, it is to be realized that the optimum configuration and relationships for the elements of the a crowdsourcing viewable events are deemed readily apparent and obvious to one skilled in the art, and all equivalent relationships to those illustrated in the images and described in the specification are intended to be encompassed by the present invention.

Therefore, the foregoing is considered as illustrative only of the principles of the crowdsourcing viewable events. Further, since numerous modifications and changes will readily occur to those skilled in the art, it is not desired to limit the center to the exact construction and operation shown and described, and accordingly, all suitable modifications and equivalents may be resorted to, falling within the scope of the a crowdsourcing viewable events. While the above description describes various embodiments of the present invention, it will be clear that the present invention may be otherwise easily adapted to satisfy any requirements for crowdsourcing viewable events.

As various changes could be made in the above configuration or organization without departing from the scope of the invention, it is intended that all matter contained in the above description or shown in the accompanying images shall be interpreted as illustrative and not in a limiting sense.

What is claimed is:

1. A method comprising:
storing information in a database wherein the information consists of information about one or more venues and information about one or more viewable events, associating at least one of the venues with at least one of the viewable events, distributing the information from the database to one or more crowdsourcing participants.

2. The method of claim 1, wherein the information about one or more venues further comprises the name of the venue.

3. The method of claim 1, wherein the information about one or more viewable events further comprises the type of the viewable event.

4. The method of claim 1, wherein the crowdsourcing participants access the database by using a computing device.

5. The method of claim 4, wherein the computing device contains an application that allows the crowdsourcing participants to access the database.

6. The method of claim 1, wherein the information about one or more venues is entered into the database by the crowdsourcing participants.

7. The method of claim 1, wherein the information about one or more viewable events is entered into the database by the crowdsourcing participants.

8. The method of claim 1, wherein the crowdsourcing participants retrieve the information from the database to find a viewable event.

9. A system for crowdsourcing viewable events comprising:
a crowdsourcing engine that associates at least one viewable event with at least one venue, a database configured to store information about a plurality of viewable events and a plurality of venues, and an application that allows a user to access the database to determine the location of the venue that was associated with one of the viewable event.

10. The system of claim 9, wherein the information about a plurality of viewable events includes information about the type of viewable events.

11. The system of claim 9, wherein the information about a plurality of venues includes the name of the venue.

12. The system of claim 9, wherein the application is executed on a computing device.

13. The system of claim 9, wherein the application further comprises a check-in function.

14. The system of claim 9, wherein the information in the database is populated by one or more users.

15. A method for crowdsourcing viewable events comprising:
receiving viewable event information from a user, receiving venue information from a user, associating a venue with a viewable event, sending the location of the venue showing the viewable event to a user.

16. The method of claim 15, wherein the viewable event information includes the type of the event.

17. The method of claim 15, wherein the venue information includes the name of the venue.

18. The method of claim 15, wherein the location of the venue is the address of the venue.

19. The method of claim 15, wherein associating a venue with a viewable event is performed by a crowdsourcing engine.

20. The method of claim 15, wherein the user uses a computer application to crowdsource viewable events.
